(19) United States
(12) Patent Application Publication
(10) Pub. No.: US 2006/0178050 A1
(43) Pub. Date: Aug. 10, 2006

(54) Receiving container, method for receiving a board and display apparatus having the receiving container

(76) Inventors: Man-Soo Kim, Seoul (KR); Dong-Choul Yang, Yongin-si (KR)

Correspondence Address: CANTOR COLBURN, LLP, 55 GRIFFIN ROAD SOUTH, BLOOMFIELD, CT, 06002, US

(21) Appl. No.: 11/349,300

(22) Filed: Feb. 7, 2006

(30) Foreign Application Priority Data
Feb. 7, 2005 (KR) 2005-11273

(51) Int. Cl. H01R 13/648

(52) U.S. Cl. 439/607

(57) ABSTRACT

In a receiving container, a method for receiving a board and a display apparatus having the receiving container, the receiving container includes a bottom portion and a receiving member. The bottom portion includes a first region receiving the board having a first side face and a second side face that is opposite to the first side face and surrounds the first region. The receiving member including a first receiving portion protruded from the second region toward the first region to receive the first side face and a second receiving portion protruded from the second region toward the first region to receive the second side face.

This application claims priority to Korean Patent Application No. 2005-11273 filed on Feb. 7, 2005, and all the benefits accruing therefrom under 35 U.S.C. §119, the contents of which are herein incorporated by reference in its entirety.

### BACKGROUND OF THE INVENTION

1. Field of the Invention

The present invention relates to a receiving container, a method for receiving a board and a display device having the receiving container. More particularly, the present invention relates to a receiving container capable of closely receiving a board, a method for receiving the board, and a display device including the receiving container.

2. Description of the Related Art

In general, a display device includes two display substrates that are opposite to each other. Electrodes are positioned on the substrates, respectively. Voltages that are different from each other are applied to the electrodes, respectively. The voltage generates a magnetic field in a liquid crystal layer positioned between the substrates. The magnetic field rearranges liquid crystal molecules in the liquid crystal layer. Thus, a transmittance of the liquid crystal layer varies. As a result, the display device displays an image by using a variation of the transmittance.

The display device includes a display panel controlling a liquid crystal layer to display images, a backlight assembly providing the display panel with light, and a driving unit providing the display panel with a driving signal. The driving unit includes a circuit board electrically connected with the display panel to provide the display panel with the driving signal. The circuit board is positioned on one face of the receiving container for receiving the display panel. In general, screws combine the circuit board and the receiving container.

However, where the screws are used for combining the circuit board and the receiving container, a combination process becomes complicated. Thus, a time required for the combination process is too long.

### SUMMARY OF THE INVENTION

An exemplary embodiment provides a receiving container including a shortened manufacturing time.

Another exemplary embodiment provides a method for receiving a board in the above receiving container.

Another exemplary embodiment provides a display device including the above receiving container.

In an exemplary embodiment in accordance with the present invention, a receiving container includes a bottom portion and at least one receiving member. The bottom portion includes a first region and a second region. The first region receives a board having a first side face and a second side face that is opposite to the first side face. The second region surrounds the first region. The receiving member includes a first receiving portion and a second receiving portion. The first receiving portion protrudes from the second region toward the first region to receive the first side face. The second receiving portion protrudes from the second region toward the first region to receive the second side face.

In an exemplary embodiment in accordance with the present invention, there is provided a method for receiving a board as follows. The board includes a first side face and a second side face that is opposite to the first side face. The first side face of the board is inserted into a first receiving portion of a receiving member. The receiving member includes the first receiving portion and a second receiving portion. The first receiving portion protrudes from the second region toward the first region. The second receiving portion protrudes from the second region toward the first region. The second side face of the board is then inserted into the second receiving portion of the receiving member.

In an exemplary embodiment in accordance with the present invention, a display device includes a display panel, a printed circuit board and a receiving container. The display panel displays images. The printed circuit board supplies an image signal to the display panel. The printed circuit board includes a first side face and a second side face that is opposite to the first side face. The receiving container includes a bottom portion and at least one receiving member. The bottom portion includes a first region and a second region. The first region receives the printed circuit board. The second region surrounds the first region. The receiving member includes a first receiving portion and a second receiving portion. The first receiving portion protrudes from the second region toward the first region to receive the first side face. The second receiving portion protrudes from the second region toward the first region to receive the second side face.

In an exemplary embodiment according to the present invention, a printed circuit board may be combined using a receiving portion including first and second portions instead of a screw so that a step difference portion combining the printed circuit with the screw may be unnecessary. Thus, the printed circuit board may be efficiently combined with the receiving container.

### BRIEF DESCRIPTION OF THE DRAWINGS

The above and other advantages of the present invention will become readily apparent by reference to the following detailed description when considered in conjunction with the accompanying drawings in which:

FIG. 1 is a perspective view illustrating an exemplary embodiment of a receiving container in accordance with the present invention;

FIG. 2 is a cross-sectional view taken along line I˜I′ shown in FIG. 1;

FIG. 3 is an enlarged cross-sectional view illustrating portion ‘A’ shown in FIG. 2;

FIG. 4 is a perspective view illustrating another exemplary embodiment of a receiving container in accordance with the present invention;

FIG. 5 is a perspective view illustrating another exemplary embodiment of a receiving container in accordance with the present invention;

FIG. 6 is a perspective view illustrating another exemplary embodiment of a receiving container in accordance with the present invention;

FIG. 7 is a perspective view illustrating another exemplary embodiment of a receiving container in accordance with the present invention;

FIG. 8 is a perspective view illustrating another exemplary embodiment of a receiving container in accordance with the present invention;

FIG. 9 is a perspective view illustrating another exemplary embodiment of a receiving container in accordance with the present invention;

FIG. 10 is a perspective view illustrating another exemplary embodiment of a receiving container in accordance with the present invention;

FIG. 11 is a cross-sectional view illustrating an exemplary embodiment of a method for receiving a circuit board;

FIG. 12 is a perspective view illustrating an exemplary embodiment of a display panel in accordance with the present invention;

FIG. 13 is an exploded perspective view of the display panel shown in FIG. 11; and

FIG. 14 is a cross-sectional view illustrating a side portion of the display panel in FIG. 13.

### DETAILED DESCRIPTION OF THE INVENTION

Example embodiments of the present invention will be described with reference to the accompanying drawings. The present invention may, however, be embodied in many different forms and should not be construed as limited to the example embodiments set forth herein. Rather, the example embodiments are provided so that disclosure of the present invention will be thorough and complete, and will fully convey the scope of the present invention to those skilled in the art. The principles and features of this invention may be employed in varied and numerous embodiments without departing from the scope of the present invention. In the drawings, the size and relative sizes of layers and regions may be exaggerated for clarity. The drawings are not to scale. Like reference numerals refer to like elements throughout.

It will be understood that when an element or layer is referred to as being “on”, “connected to” and/or “coupled to” another element or layer, the element or layer may be directly on, connected and/or coupled to the other element or layer or intervening elements or layers may be present. In contrast, when an element is referred to as being “directly on,” “directly connected to” and/or “directly coupled to” another element or layer, there may be no intervening elements or layers present. As used herein, the term “and/or” may include any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms may be used to distinguish one element, component, region, layer and/or section from another element, component, region, layer and/or section. For example, a first element, component, region, layer and/or section discussed below could be termed a second element, component, region, layer and/or section without departing from the teachings of the present invention.

Spatially relative terms, such as “beneath,” “below,” “lower,” “above,” “upper” and the like may be used to describe an element and/or feature's relationship to another element(s) and/or feature(s) as illustrated in the figures. It will be understood that the spatially relative terms are intended to encompass different orientations of the device in use and/or operation in addition to the orientation depicted in the figures. For example, if the device in the figures is turned over, elements described as “below” and/or “beneath” other elements or features would then be oriented “above” the other elements or features. The device may be otherwise oriented (rotated 90 degrees or at other orientations) and the spatially relative descriptors used herein interpreted accordingly.

The terminology used herein is for the purpose of describing particular embodiments only and is not intended to limit of the invention. As used herein, the singular terms “a,” “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence and/or addition of one or more other features, integers, steps, operations, elements, components, and/or groups thereof.

Unless otherwise defined, all terms (including technical and scientific terms) used herein may have the same meaning as what is commonly understood by one of ordinary skill in the art. It will be further understood that terms, such as those defined in commonly used dictionaries, should be interpreted as having a meaning that is consistent with their meaning in the context of the relevant art and will not be interpreted in an idealized and/or overly formal sense unless expressly so defined herein.

Example embodiments of the present invention are described with reference to cross-section illustrations that are schematic illustrations of idealized embodiments of the present invention. As such, variations from the shapes of the illustrations as a result, for example, of manufacturing techniques and/or tolerances, are to be expected. Thus, example embodiments of the present invention should not be construed as limited to the particular shapes of regions illustrated herein but are to include deviations in shapes that result, for example, from manufacturing. Thus, the regions illustrated in the figures are schematic in nature of a device and are not intended to limit the scope of the present invention.

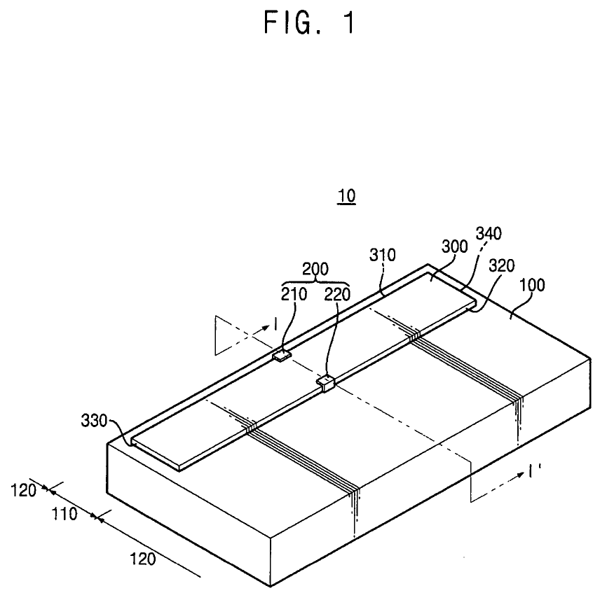

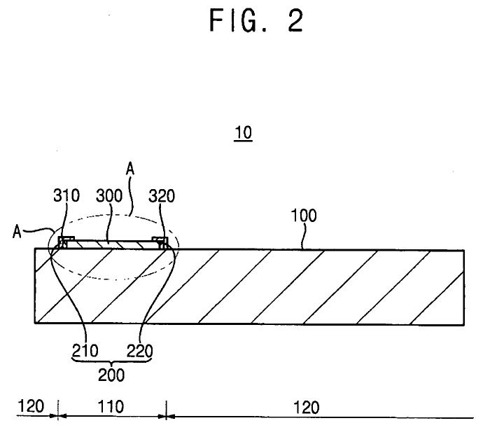

FIG. 1 is a perspective view illustrating an exemplary embodiment of a receiving container in accordance with the present invention. FIG. 2 is a cross-sectional view taken along line I-I′ in FIG. 1.

Referring to FIGS. 1 and 2, a receiving container 10 includes a bottom portion 100 and a receiving member 200 that receives a board 300.

In exemplary embodiments, the board 300 may be a printed circuit board. In case that the board 300 has a rectangular plate shape, the board 300 has a bottom face having a rectangular shape, a top face opposite to the bottom face, a first side face 310 connected between the bottom face and the top face, a second side face 320 opposite to the first side face 310, a third side face 330 connected between the first side face 310 and the second side face 320, and a forth side face 340 opposite to the third side face 330.

The receiving container 10 includes the bottom portion 100 for receiving the board 300 thereon.

The bottom portion 100 includes a first region 110 on which the board 300 is mounted and a second region 120 surrounding the first region 110. An area of the first region 110 is substantially similar to that of the bottom face of the board 300. In addition, a shape of the first region 110 is substantially similar to that of the bottom face of the board 300. In an exemplary embodiment the bottom face of the board 300 and the first region 110 have rectangular shapes.

The receiving member 200 is positioned on the bottom portion 100 to receive the board 300. The receiving member 200 includes a first receiving portion 210 and a second receiving portion 220.

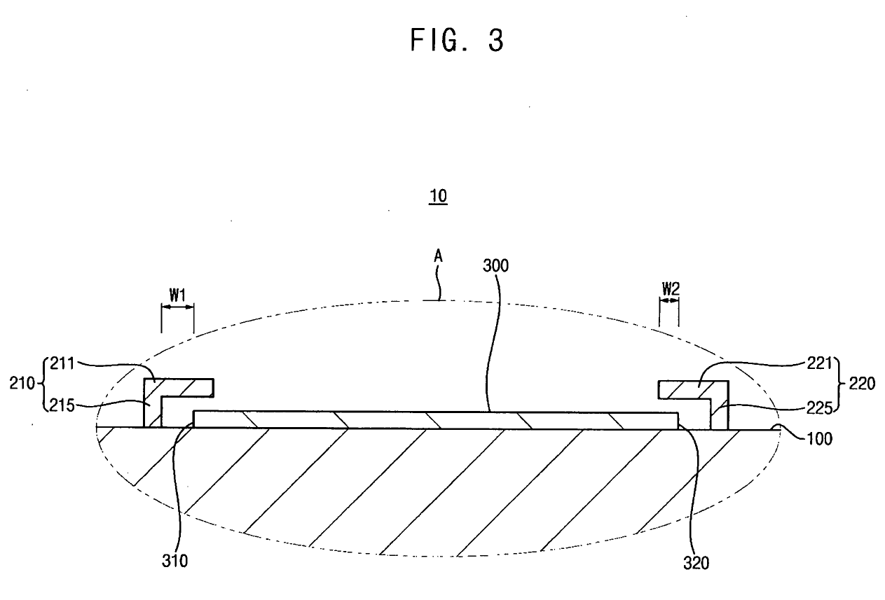

The first receiving portion 210 protrudes in a direction from the second region 120 toward the first region 110. The first receiving portion 210 receives the first side face 310 of the board 300. As illustrated in the exemplary embodiment of FIG. 1, the first receiving portion 210 may receive a central portion of the first side face 310 of the board 300. In other exemplary embodiments, the first receiving portion 210 may be disposed at any point along the first side face 310 as is suitable for the purpose described herein. Referring to FIG. 3, the first receiving portion 210 includes a first fixing portion 211 and a first connection portion 215.

The first fixing portion 211 is positioned over the bottom portion 100. The first fixing portion 211 is substantially parallel to the bottom portion 100. In exemplary embodiments, the first fixing portion 211 may apply pressure around the first side face 310 of the board 300. Advantageously, the first fixing portion 211 enables the board 300 to make close contact with and be held securely against the first region 110.

The first connection portion 215 is extends between the first fixing portion 211 and the bottom portion 100. The first connection portion 215 is vertically protruded from the bottom portion 100 at an area between the first region 110 and the second region 120. The first connection portion 215 is substantially perpendicular to the bottom portion 100. As in the illustrated exemplary embodiment, the first receiving portion 210 may have an L-shape. The first fixing portion 211, the first connection portion 215 and the bottom portion 100 define a first hole.

A second receiving portion 220 protrudes in a direction from the second region 120 toward to the first region 110. The second receiving portion 220 may receive the second side face 320 of the board 300. Similar to the first receiving portion 210, the second receiving portion 220 may be disposed at a central portion or any of a number of point along the second side face 320 as is suitable for the purpose described herein. The second receiving portion 220 includes a second fixing portion 221 and a second connection portion 225.

The second fixing portion 221 is positioned over the bottom portion 100. The second fixing portion 221 is substantially parallel with the bottom portion 100. In exemplary embodiments, the second fixing portion 221 may apply pressure around the second side face 320 of the board 300. Advantageously, thus, the second fixing portion 221 enables the board 300 to make close contact with and be held securely against the first region 110.

The second connection portion 225 extends between the second fixing portion 221 and the bottom portion 100. The second connection portion 225 is vertically protruded from the bottom portion 100 at an area between the first region 110 and the second region 120. The second connection portion 225 is substantially perpendicular to the bottom portion 100. As in the illustrated exemplary embodiment, the second receiving portion 220 may have an L-shape. The second fixing portion 221, the second connection portion 225 and the bottom portion 100 define a second hole.

The first receiving portion 210 and the second receiving portion 220 may be opposite to each other such that the first hole and the second hole may also be opposite to each other. As in the exemplary embodiment illustrated in FIG. 1, the first receiving portion 210 may be positioned adjacent to the central portion of the first side face 310 of the board 300 and the second receiving portion 220 may be positioned adjacent to a central portion of the second side face 320 of the board 300. The receiving member 200 including the first receiving portion 210 and the second receiving portion 220 opposite to each other may firmly receive the board 300.

FIG. 3 is an enlarged view illustrating portion “A” shown in FIG. 2.

Referring to FIG. 3, the first side face 310 of the board 300 and the first connection portion 215 of the first receiving portion 210 are apart from each other by a first width (W1). The second fixing portion 221 is partially overlapped with the board 300 by a second width (W2). In exemplary embodiments, the first width (W1) may be no less than the second width (W2).

The second side face 320 of the board 300 is inserted into the second receiving portion 220, such that the board 300 is received in the receiving member 200. The first side face 310 of the board 300 is then inserted into the first receiving portion 210. Thus, the board 300 may be received into the receiving container 10.

In alternative embodiments, the first face 310 of the board 300 is inserted into the first receiving portion 210. The second side face 320 of the board 300 is then inserted into the second receiving portion 220. Thus, the board 300 may be received into the receiving container 10.

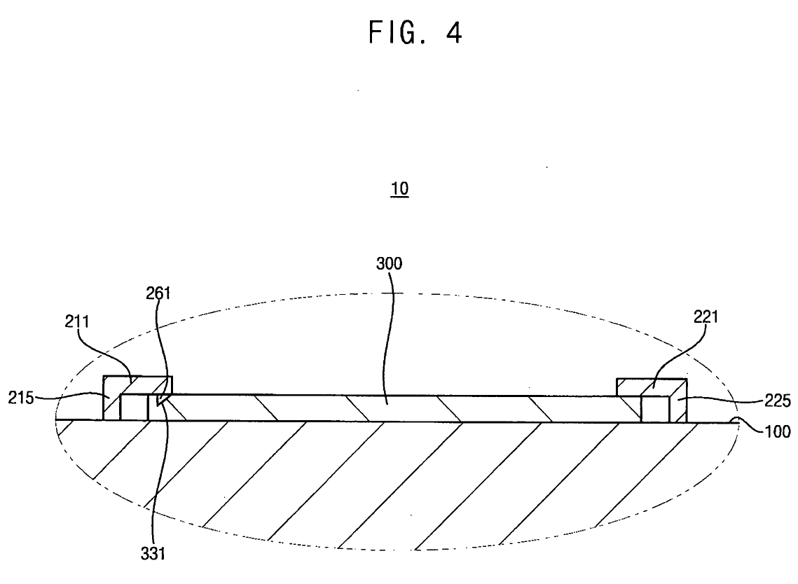

FIG. 4 is a perspective view illustrating another exemplary embodiment of a receiving container in accordance with the present invention.

The receiving container 10 includes a receiving member 200 having a first receiving portion 210 and a second receiving portion 220. The first receiving portion 210 includes a first fixing portion 211 and a first connection portion 215.

The first fixing portion 211 includes a first combination portion 261.

The first combination portion 261 is positioned on a first face of the first fixing portion 211, the first face facing the bottom portion 100. The first combination portion 261 may be a protrusion protruded from the first face of the first fixing portion 211 toward a bottom portion 100. A width of the combination portion 261 may decrease from wide to narrow in a direction away from the first connection portion 211 toward the bottom portion 100. As in the illustrated exemplary embodiment of FIG. 4, the first combination portion 261 is essentially wedge or triangular-shaped.

The first combination portion 261 enables the board 300 to be firmly combined with the first receiving portion 210.

The board 300 includes a second combination portion 331 combined with the first portion 261. In exemplary embodiments, the second combination portion 331 may be a recess. The second combination portion 331 is configured to receive or join with the first combination portion 261 such that the first receiving portion 210 securely joins with the board 300.

The first combination portion 261 and the second combination portion 331 together enable the board 300 to be firmly combined with the first receiving portion 210. That is, the first combination portion 261 and the second combination portion 331 enable the board 300 to make close contact with the bottom portion 100.

As illustrated in FIG. 4, only the first receiving portion 210 includes the first and second combination portions 261 and 331. In alternative embodiments, only the second receiving portion 220 may include the first and second combination portions 261 and 331. In other alternative embodiments, both the first and second receiving portions 210 and 220 may include the first and second combination portions 261 and 331.

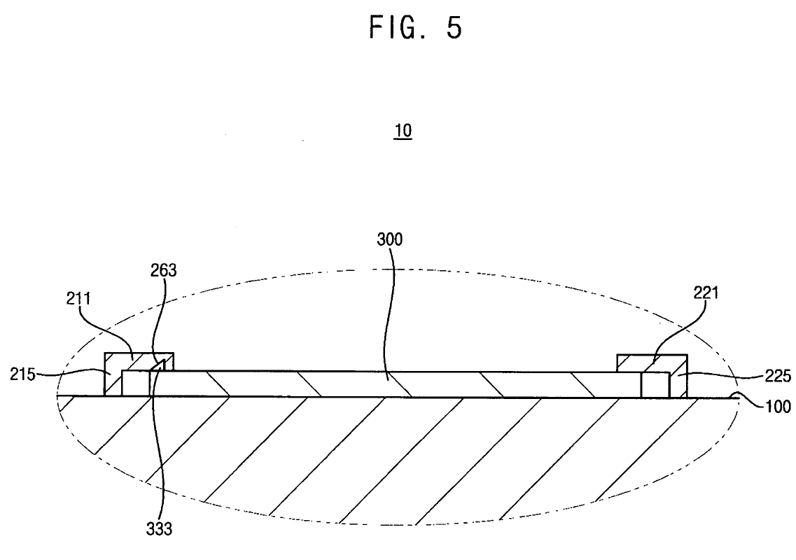

FIG. 5 is a perspective view illustrating another exemplary embodiment of a receiving container in accordance with the present invention.

The receiving container 10 includes a receiving member 200 including a first receiving portion 210 and a second receiving portion 220. The first receiving portion 210 includes a first fixing portion 211 and a first connection portion 215.

The first fixing portion 211 includes a first combination portion 263. The first combination portion 263 is formed at a lower portion or bottom face of the first fixing portion 211, the lower portion being opposite to a bottom portion 100. In exemplary embodiments, the first combination portion 263 may be a recess.

The board 300 includes a second combination portion 333 combined with the first combination portion 263. In other exemplary embodiments, the second combination portion 333 may be a protrusion. The first and second combination portions 263 and 333 are configured in any of a number of shapes such that the first receiving portion 210 securely joins with the board 300.

The first combination portion 263 and the second combination portion 333 together may firmly combine the board 300 with the first receiving portion 210. That is, the first combination portion 263 and the second combination portion 333 together may allow the board 300 to make close contact with the bottom portion 100.

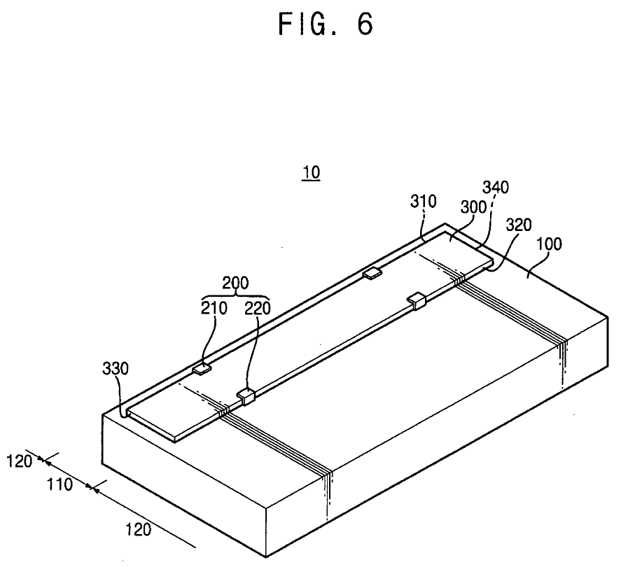

FIG. 6 is a perspective view illustrating another exemplary embodiment of a receiving container in accordance with the present invention.

Referring to FIG. 6, a receiving member 200 includes a first receiving portion 210 and a second receiving portion 220. The first receiving portion 210 receives a first side face 310 of a board 300. The second receiving portion 220 receives a second side face 320 of the board 300.

The receiving container 10 may include at least two first receiving portions 210 and at least two second receiving portions 220. Each of the first receiving portions 210 is opposite to each of the second receiving portions 220. Thus, the receiving container 10 may firmly receive the board 300.

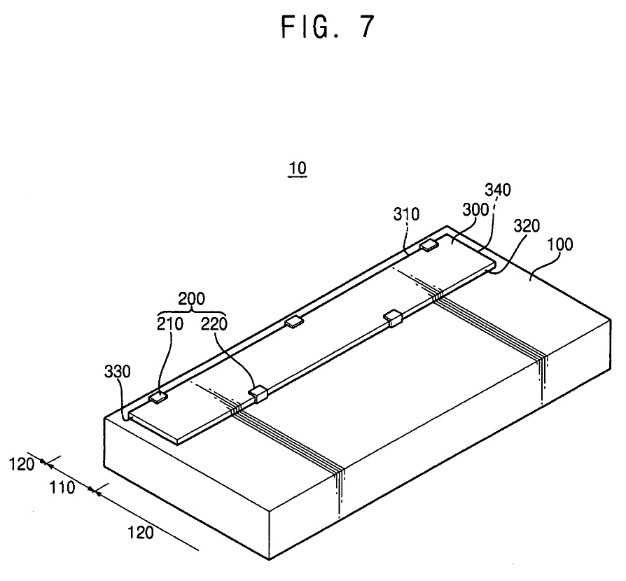

FIG. 7 is a perspective view illustrating another exemplary embodiment of a receiving container in accordance with the present invention.

Referring to FIG. 7, a receiving member 200 includes a first receiving portion 210 and a second receiving portion 220. The first receiving portion 210 receives a first side face 310 of a board 300. The second receiving portion 220 receives a second side face 320 of the board 300.

The receiving container 10 may include at least two first receiving portions 210 and at least two second receiving portions 220 as illustrated in FIG. 7. The first receiving portions 210 and the second receiving portions 220 are alternately arranged in a zigzag shape in a longitudinal direction of the board 300. The first receiving portions 210 and the second receiving portions 220 are not opposite each other. The zigzag shape enables stress applied to the board 300 to be efficiently dispersed. Thus, the receiving member 200 may enable the board 300 to make close contact with the bottom portion 100.

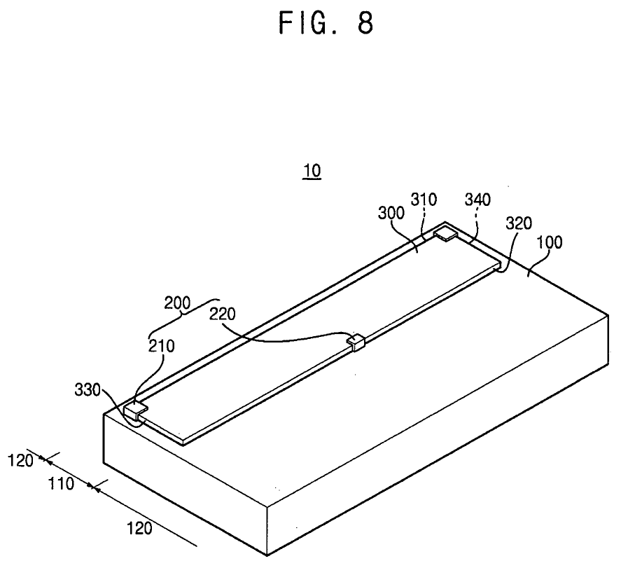

FIG. 8 is a perspective view illustrating another exemplary embodiment of a receiving container in accordance with the present invention.

Referring to FIG. 8, a receiving member 200 includes a first receiving portion 210 and a second receiving portion 220.

The board 300 has a rectangular plate shape including a bottom face, a top face opposite to the bottom face, a first side face 310 connected between the bottom face and the top face, a second side face 320 opposite to the first side face 310, a third side face 330 connected between the first side face 310 and the second side face 320 and a fourth side face 340 opposite to the third side face 330.

The receiving container 10 may include at least two first receiving portions 210. The first receiving portions 210 are positioned around a first edge portion where the first side face 310 and the third side face 330 are connected and around a second edge portion where the first side face 310 and the fourth side face 340 are connected. The first and second edge portions are essentially at corners of the board 300.

In alternative embodiments, the receiving container 10 may include at least two second receiving portions 220. The second receiving portions 220 may be positioned around a third edge portion where the second side face 320 and the third side face 330 are connected and around a fourth edge portion where the second side face 320 and the fourth side face 340 are connected. The third and second edge portions are essentially at corners of the board 300.

Thus, the receiving member 200 may enable the board 300 to make close contact with a bottom portion 100.

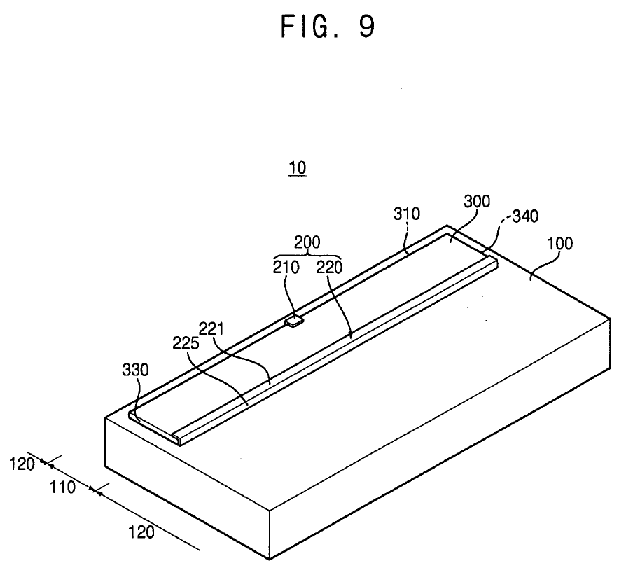

FIG. 9 is a perspective view illustrating another exemplary embodiment of a receiving container in accordance the present invention. Referring to FIG. 9, a receiving member 200 includes a first receiving portion 210 and a second receiving portion 220.

The second receiving portion 220 may receive a second side face 320 of a board 300. The second receiving portion 220 extends substantially in parallel with the bottom portion 100. The second receiving portion 220 may include a second fixing portion 221 and a second connection portion 225. The second fixing portion 221 may apply pressure around the second side face 320 such that the board 300 may make close contact with the bottom portion 100. The second connection portion 225 is connected between the second fixing portion 221 and the bottom portion 100. In exemplary embodiments, the second receiving portion 220 may have an L-shape.

The second connection portion 225 may be substantially in parallel with the side face 320 of the board 300. A length of the second receiving portion 220 may extend substantially the entire length of the second side face 320 of the board 300 so that the second receiving portion 220 may fully cover the second side face 320 of the board 300 therewith. The receiving portion 220 may extend for any length as is suitable for the purpose described herein. In exemplary embodiments, the second fixing portion 221, the second connection portion 225 or both may extend substantially the entire length or extend only a partial length of the second side 320 of the board 300. Thus, the second receiving portion 220 enables the board 300 to make close contact with the bottom portion 100.

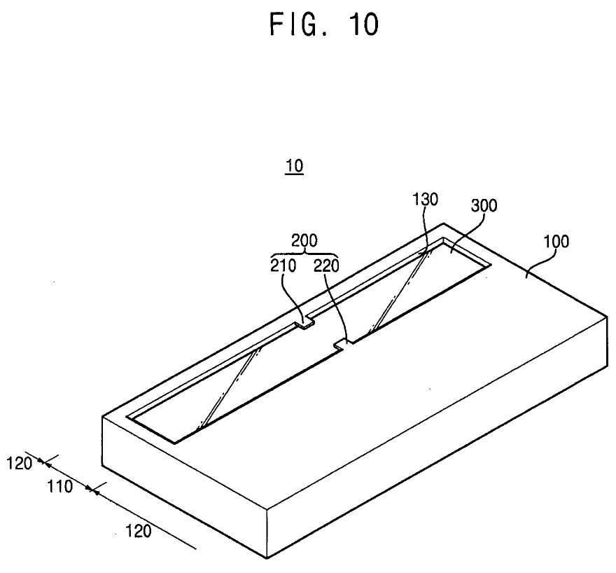

FIG. 10 is a perspective view illustrating another exemplary embodiment of a receiving container in accordance with the present invention.

Referring to FIG. 10, an opening 130 is formed at the first region 110 of the bottom portion 100. The opening 10 receives the board 300 therein. A shape of the opening 130 may vary in accordance with a shape of the board 300. In exemplary embodiments, where the board 300 has a rectangular plate shape, the opening 130 may have a rectangular plate shape. A thickness of the board 300 may be substantially identical to a depth of the opening 130.

The board 300 is received in the opening 130 such that the board minimally protrudes from a surface of the bottom portion 100. Advantageously, as stress is applied to the bottom portion 100 that has the opening 130 in which the board 300 is received, the board 300 may be minimally or not damaged. In addition, though the receiving container 10 may be tipped or slanted, the opening 130 prevents the board 300 from being misarranged in the receiving container 10.

The receiving member 200 includes a first and a second receiving portion 210 and 220 extending from an upper edge of the opening 130 towards a center portion of the opening 130. The first and second receiving portions 210 and 220 may be rectilinear in shape or any shape suitable for the purpose described herein. As illustrated in FIG. 10, the receiving member 200 includes tab-like members that are substantially in parallel to the bottom portion 100. The first and second receiving portions 210 and 220 are configured such as to securely hold the board 300 in the opening 130.

While the receiving member 200 is illustrated in FIG. 10 as being in a center portion of the longitudinal side of the opening, the receiving member 200 may be at any point along the longitudinal side of the opening 130. In alternative embodiments, there may be more than one receiving member 200, more than one first receiving portion 210, more than one second receiving portion 220, or any combination including at least one of the foregoing.

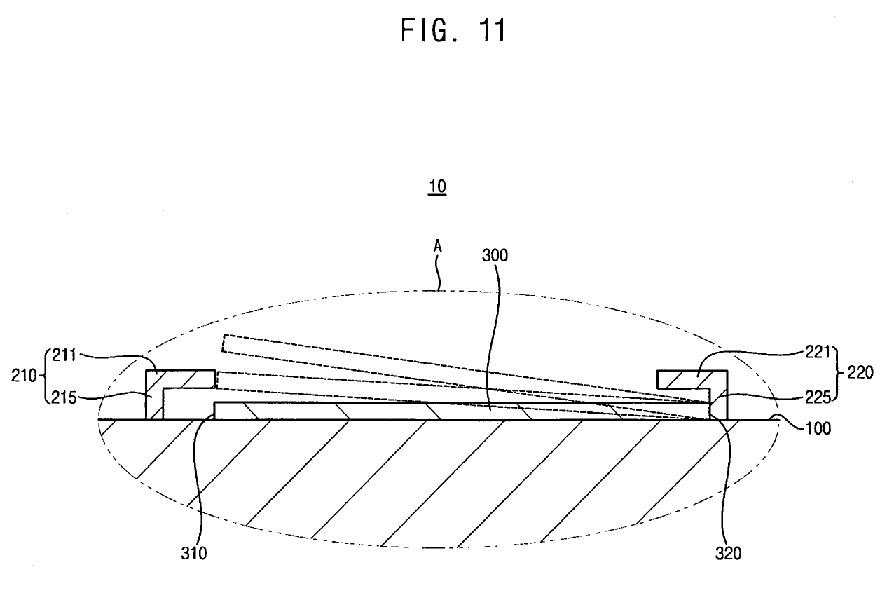

FIG. 11 is a cross-sectional view illustrating an exemplary embodiment of a method for receiving a board. Referring to FIGS. 3 and 11, the first side face of the board 300 is apart from the first connection portion 215 of the first receiving portion 210 by a first width (W1). The second fixing portion 221 is partially overlapped with the board 300 by the second width (W2). The first width (W1) may be no less than the second width (W2).

In order to place the board 300 into the receiving member 200, the second side face 320 of the board 300 is inserted into a second receiving portion 220. The second side face 320 of the board 300 may be inserted into the second receiving portion 220 until the second side face 320 makes contact with a second connection portion 225 of the second receiving portion 220. A first side face 310 of the board 300 is then inserted into the first receiving portion 210. The first side face 310 of the board 300 clears an end of the first fixing portion 211 and is brought into contact with the bottom portion 100 of the board 300. Thus, the board 300 is received in a receiving container 10.

In alternative embodiments, the first side face 310 of the board 300 may be inserted into the first receiving portion 210 first. The second side face 320 of the board 300 may then inserted into the second receiving portion 220. Thus, the board 300 is received in the receiving container 10.

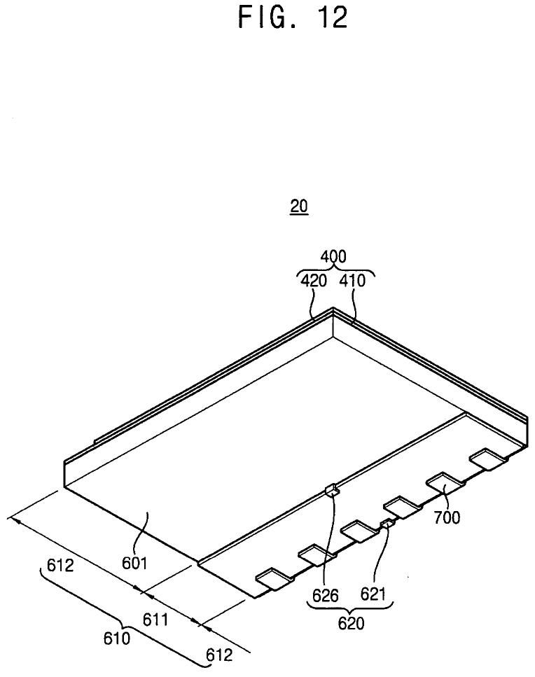

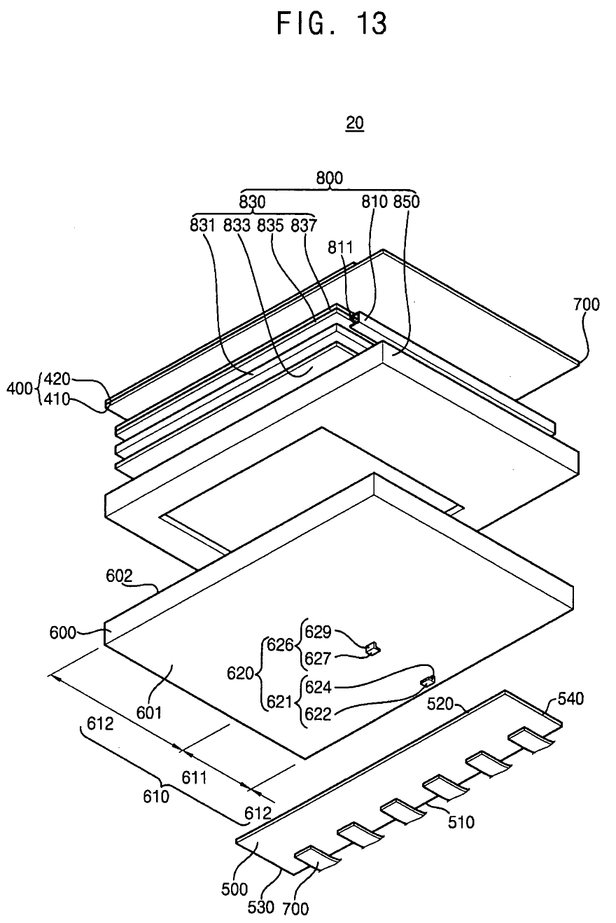

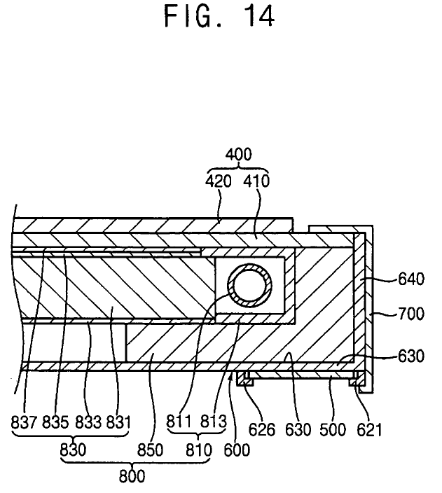

FIG. 12 is a perspective view illustrating an exemplary embodiment of a display apparatus in accordance with the present invention. FIG. 13 is an exploded perspective view illustrating the display apparatus shown in FIG. 12. FIG. 14 is a cross-sectional view illustrating a side portion of the display panel in FIG. 13. Referring to FIGS. 12 to 14, a display apparatus 20 includes a display panel 400, a printed circuit board 500, and a receiving container 600. The display panel 400 may include a flexible printed circuit 700 electrically connected between the display panel 400 and the printed circuit board 500.

A drive signal is applied into the display panel 400 so that the display panel 400 displays images. The display panel 400 includes a first substrate 410, a second substrate 420 and a liquid crystal layer (not shown) therebetween.

The first substrate 410 includes pixel electrodes (not shown) arranged in a matrix shape, thin film transistors (TFT) (not shown) for applying drive voltages into the pixel electrodes, and signal lines (not shown) driving the thin film transistors. Pads (not shown) receiving electrical signals may be positioned at end portions of the signal lines.

The second substrate 420 may be opposite to the first substrate 410. An area of the second substrate 420 may be substantially less than that of the first substrate 420. In exemplary embodiments, the second substrate 420 may include a common electrode (not shown) and a color filter pattern (not shown).

The common electrode is opposite to the pixel electrodes positioned in the first substrate 410. Voltage applied between the common electrode and each of the pixel electrodes generates a magnetic field between the common electrode and each of the pixel electrodes. In alternative embodiments, the common electrode may be positioned on the first substrate 410.

The color filter pattern is opposite to each of the pixel electrodes positioned on the first substrate 410. The color filter pattern is positioned on the second substrate 420. In alternative embodiments, the color filter pattern may be positioned on the first substrate 410.

The liquid crystal layer is positioned between the first substrate 410 and the second substrate 420. The magnetic field generated between each of the pixel electrodes and the common electrode rearranges liquid crystal molecules in the liquid crystal layer. Thus, a light transmittance of a light incident through the first substrate 410 or the second substrate 420 may vary.

The printed circuit board 500 is electrically connected with the display panel 400 to generate a driving signal that drives the display panel 400. In exemplary embodiments, the printed circuit board 500 may correspond to a data printed circuit board.

The printed circuit board 500 may have a rectangular plate shape as illustrated in the exemplary embodiment of FIGS. 12 and 13. Where that the printed circuit board 500 has the rectangular plate shape, the printed circuit board 500 may include a bottom face, a top face opposite to the bottom face, a first side face 510 connected between the bottom face and the top face, a second side face 520 opposite to the first side face 510, a third side face 530 connected between the first side face 510 and the second side face 520, and the fourth side face 540 opposite to the third side face.

The receiving container 600 has a first face 601 and a second face 602 opposite to the first face 601. The board 500 is mounted on the first face 601 of the receiving container 600. The display panel 400 is mounted on the second face 602 of the receiving container 600.

The first face 601 of the receiving container 600 includes a first bottom portion 610 and a receiving member 620.

The first bottom portion 610 includes a first region 611 where the printed circuit board 500 is received and a second region 612 surrounding the first region 611. An area of the first region 611 may be substantially similarly to that of the board 500. A shape of the first region 611 may be substantially similar to that of the board 500. In exemplary embodiments, where the printed circuit board 500 has a rectangular plate shape, the first region 611 may have a rectangular shape.

The receiving member 620 is positioned on the first bottom portion 610. The receiving member 620 includes a first receiving portion 621 and a second receiving portion 626.

The first receiving portion 621 protrudes from the second region 612 toward the first region 611. The first receiving portion 621 receives the first side face 510 of the printed circuit board 500. The first receiving portion 621 may be formed around a central portion of the first side face 510. The first receiving portion 621 includes a first fixing portion 622 and a first connection portion 624.

The first fixing portion 622 is substantially parallel with the first bottom portion 610. The first fixing portion 622 applies pressure around the first side face 510 of the printed circuit board 500. Thus, the first fixing portion 622 enables the printed circuit board 500 to make close contact with the first region 611.

The first connection portion 624 is connected between the first fixing portion 622 and the first bottom portion 610. The first connection portion 624 protrudes from a portion of the first bottom portion 601 in an area substantially between the first region 611 and the second region 612. The first connection portion 624 may be substantially perpendicular to the first bottom portion 610. The first receiving portion 621 may have an L-shape.

In alternative embodiments, the first fixing portion 622 of the first receiving portion 621 may include a first combination portion at a lower portion thereof, the lower portion facing the printed circuit board 500. The printed circuit board 500 may include a second combination portion configured to combine with the first combination portion of the first fixing portion 622.

Where the first combination portion of the fixing portion 622 is a protrusion that protrudes from a lower face of the first fixing portion 622 toward the first bottom portion 601 of the receiving container 20, the second combination portion of the printed circuit board 500 may be a recess configured to combine with the protrusion. In other alternative embodiments, where the first combination portion of the fixing portion 622 is a recess, the second combination portion of the printed circuit board 500 may be a protrusion configured to combine with the recess.

The second receiving portion 626 protrudes from the second region 612 toward the first region 611. The second receiving portion 626 receives the second side face 520 of the printed circuit board 500. The second receiving portion 626 includes a second fixing portion 627 and a second connection portion 629.

The second fixing portion 627 is substantially in parallel with the first bottom portion 610. The second fixing portion 627 applies pressure around the second side face 520 of the printed circuit board 500. Thus, the second fixing portion 627 enables the printed circuit board 500 to make close contact with the first region 611 of the first bottom portion 610.

The second connection portion 629 is connected between the second fixing portion 627 and the first bottom portion 610. The second connection portion 629 may be upwardly protruded from a portion of the first bottom portion 601 in an area substantially between the first region 611 and the second region 612. The second connection portion 629 is substantially perpendicular to the first bottom portion 610. The second receiving portion 626 may have an L-shape.

In addition, the second connection portion 629 may be in parallel with the second side face 520 of the printed circuit board 500. Thus, the second fixing portion 627 may have a length substantially identical to that of the second side face 520 of the printed circuit board 500.

The first receiving portion 621 and the second receiving portion 626 may be opposite to each other as illustrated in FIGS. 12 and 13. Where the first receiving portion 621 is positioned around the central portion of the first side face 510, the second receiving portion 626 may be positioned around a central portion of the second side face 520. The first receiving portion 621 and the second receiving portion 626 opposite to each other may enable the printed circuit board 500 to make close contact with the first region 611.

In alternative embodiments, the receiving container 600 may include at least two first receiving portions 621 and at least two second receiving portions 626. Each of the first receiving portions 621 may be opposite to each of the second receiving portions 626.

In other alternative embodiments, the receiving container 600 may include at least two receiving portions 621 and at least two second receiving portions 626. The first receiving portions 621 and the second receiving portions 626 may be alternately arranged in a zigzag shape, or not opposite of each other in staggered positions along a longitudinal side of the board 500.

The receiving container 600 receives the display panel 400 on the second face 602 opposite to the first face 601.

The receiving container 600 includes a second bottom portion 630 that has the second face 602. The receiving container 600 also includes sidewalls 640 vertically extended from an edge of the second bottom portion 630 toward the display panel 400. Thus, the second bottom portion 630 and the sidewalls 640 together define a receiving region where the display panel 400 is to be received. The sidewalls 640 include stepped portions supporting the display panel 400.

The flexible printed circuit 700 includes a wire (not shown) for an electrical connection and an insulation layer (not shown). A flexible printed circuit 700 includes material having a flexible characteristic. A first portion of the flexible printed circuit 700 is electrically connected with the first substrate 410 of the display panel 400. A second portion of the flexible printed circuit 700 is electrically connected with the printed circuit board 500. Thus, the drive signal generated from the printed circuit board 500 is applied to the first substrate 410 of the display panel 400 through the flexible printed circuit 700.

The flexible printed circuit 700, the printed circuit board 500 and the receiving container 600 are combined with each other as follows.

The flexible printed circuit 700 connected with the printed circuit board 500 is bent toward the first face 601 with enclosing one of sidewalls 640 of the receiving container 600 so that the printed circuit board 500 is positioned on the first bottom portion 610 of the receiving container 600. The second side face 520 of the printed circuit board 500 is inserted into the second receiving portion 626. The first side face 510 of the printed circuit board 500 is then inserted into the first receiving portion 621. Thus, the printed circuit board 500 is mounted on the first region 611 of the first bottom portion 610.

The display device 20 may include a backlight assembly 800 providing the display panel 400 with a light.

The backlight assembly 800 may include a lamp unit 810, an optical unit 830, and a mold frame 850.

The lamp unit 810 includes a lamp 811 and a lamp reflective plate 813. The lamp unit 810 generating the light is supplied to the display panel 400.

The optical unit 830 includes a light guide panel 831 and a plurality of optical sheets.

The light guide panel 831 has a quadrangular plate shape as illustrated in FIG. 13. In exemplary embodiments, the light guide panel 831 may include plastic that has a good mechanical strength, a good chemical endurance, and a good transmittance with respect to a visible ray.

The light is incident onto one side face of the light guide panel 831 from the lamp unit 810.

The optical sheets include a reflective sheet 833, a dispersion sheet 835 and a prism sheet 837. The optical sheets improve optical characteristics of the light generated by the lamp unit 810.

The reflective sheet 833 is positioned between the second bottom portion 630 of the receiving container 600 and the light guide panel 831 such that a light incident toward the second bottom portion 630 may be reflected toward the light guide panel 831. The dispersion sheet 835 is positioned between the light guide panel 831 and the display panel 400 such that a light irradiated from the light guide panel 831 may be dispersed by the dispersion sheet 835. The prism sheet 837 is positioned between the dispersion sheet 835 and the display panel 400 such that a light irradiated form the dispersion sheet 835 is reflected and refracted. Advantageously, a brightness of the light may be improved in a direction substantially perpendicular to the second bottom portion 630.

The mold frame 850 receives the lamp unit 810 and the optical unit 830.

The display device 20 may include a top chassis (not shown) combined with the receiving container 600 around an upper portion of the receiving container 600. The top chassis protects the display panel 400. The top chassis prevents the display panel 400 drifting from the receiving container 600.

Hereinafter, a combination order of the display device will be illustrated in accordance with FIGS. 12 and 13.

The mold frame 850, the reflective sheet 833 and the light guide panel 831 are sequentially received in the receiving container 600. The lamp unit 810 is then positioned between the light guide panel 831 and one side face of the mold frame 850. Thereafter, the dispersion sheet 835 and the prism sheet 837 are positioned on the light guide panel 831.

Subsequently, the display panel 400 is positioned on a sidewall of the mold frame 850. Here, the flexible printed circuit 700 connected with the display panel 400 is bent along one sidewall of the receiving container 600 toward the first bottom portion 610 such that the printed circuit board 500 connected with the flexible printed circuit 700 may be positioned on the first bottom portion 610 of the receiving container 600.

The first and second receiving portions 621 and 626 formed on the first bottom portion 610 receive the first and second side faces 510 and 520 of the printed circuit board 500. Thus, the printed circuit board 500 may be received on the first bottom portion 610.

In an exemplary embodiment according to the present invention, a printed circuit board may be combined using a receiving portion including first and second portions instead of a screw such that a stepped portion combining the printed circuit with the screw may be unnecessary. Advantageously, the printed circuit board may be efficiently combined.

As described above, the display apparatus in FIG. 12 includes both the receiving container 600 and the mold frame 850. In alternative exemplary embodiments, the display apparatus may include the mold frame 850 alone. That is, where the display apparatus includes the mold frame 850 alone, the display device may not include the receiving container 600. In case that the display apparatus includes the mold frame 850 alone, the display apparatus may be employed as a portable monitor in a notebook. In addition, where the display apparatus includes the mold frame 850 alone, the receiving member 620 may be formed on the mold frame 850. In other alternative embodiments, where the display apparatus includes both the receiving container 600 and the mold frame 850, the display apparatus may be employed as a desk top monitor in a desk top computer or a television.

The foregoing is illustrative of the present invention and is not to be construed as limiting thereof. Although a few embodiments of this invention have been described, those skilled in the art will readily appreciate that many modifications are possible in the embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

What is claimed is:

1. A receiving container comprising:
a bottom portion comprising a first region and a second region, the first region receiving a board comprising a first side face and a second side face that is opposite to the first side face, the second region surrounding the first region; and
at least one receiving member comprising a first receiving portion and a second receiving portion, the first receiving portion protruding from the second region toward the first region to receive the first side face, and the second receiving portion protruding from the second region toward the first region to receive the second side face.

2. The receiving container of claim 1, wherein the first receiving portion is opposite the second receiving portion.

3. The receiving container of claim 1, wherein the first receiving portion is configured in an L-shape.

4. The receiving container of claim 1, wherein the first receiving portion is substantially parallel with the bottom portion and comprises a first fixing portion and a first connection portion, the first fixing portion configured to enable the board to make close contact with the first region and the first connection portion being connected between the bottom portion and the first fixing portion.

5. The receiving container of claim 4, wherein the first fixing portion comprises a first combination portion at a lower portion of the first fixing portion, the lower portion facing the bottom portion and the board comprises a second combination portion configured to be combined with the first combination portion.

6. The receiving container of claim 5, wherein the first combination portion is a protrusion and the second combination portion is a recess.

7. The receiving container of claim 6, wherein the protrusion includes an edge slanted in a direction from the lower portion of the first fixing portion toward the bottom portion.

8. The receiving container of claim 5, wherein the first combination portion is a recess and the second combination portion is a protrusion.

9. The receiving container of claim 1, further comprising at least two receiving members spaced apart from each other.

10. The receiving container of claim 9, wherein each of the first receiving portions are opposite each of the second receiving portions.

11. The receiving container of claim 9, wherein the first receiving portions and the second receiving portions are alternately arranged in a longitudinal direction of the board.

12. The receiving container of claim 9, wherein a number of first receiving portions and a number of second receiving portions are different.

13. The receiving container of claim 1, wherein the first receiving portion is positioned at corner edges of the board including both ends of the first side face.

14. The receiving container of claim 1, wherein the second receiving portion is substantially parallel with the bottom portion and comprises a second fixing portion and a second connection portion, the second fixing portion configured to enable the board to make close contact with the first region, and the second connection portion being connected between the bottom portion and the second fixing portion.

15. The receiving container of claim 14, wherein the second connection portion is substantially parallel with the second side face and a length of the second fixing portion is substantially similar to that of the second side face.

16. The receiving container of claim 1, wherein the first region comprises an opening.

17. The receiving container of claim 16, wherein the opening comprises a shape corresponding to that of the board, a thickness corresponding to that of the board, or both.

18. The receiving container of claim 16, wherein the first receiving portion, the second receiving portion, or both protrude substantially parallel to the bottom portion from an upper edge of the opening towards a center area of the opening and are configured to securely hold the board in the opening.

19. A method for receiving a board into a receiving member, the method comprising:
inserting a first side face of the board into a first receiving portion of the receiving member, the board comprising the first side face and a second side face that is opposite to the first side face and the receiving member comprising the first receiving portion, a second receiving portion, a first region and a second region, the first receiving portion protruding from the second region toward the first region and the second receiving portion protruding from the second region toward the first region; and
inserting the second side face of the board into the second receiving portion of the receiving member.

20. A display device comprising:
a display panel displaying images;
a printed circuit board supplying an image signal to the display panel, the printed circuit board having a first side face and a second side face that is opposite to the first side face; and
a receiving container comprising a bottom portion and at least one receiving member, the bottom portion comprising a first region and a second region, the first region receiving the printed circuit board, the second region surrounding the first region, the receiving member comprising a first receiving portion and a second receiving portion, the first receiving portion protruding from the second region toward the first region to receive the first side face, and the second receiving portion protruding from the second region toward the first region to receive the second side face.

21. The display device of claim 20, wherein the first receiving portion and the second receiving portion are alternately arranged along a longitudinal direction of the board.

22. The display device of claim 20, wherein the first receiving portion is substantially in parallel with the bottom portion and comprises a first fixing portion and a first connection portion, the first fixing portion configured to enable the board to make close contact with the first region and the first connection portion being connected between the first fixing portion and the bottom portion.

23. The display device of claim 22, wherein the first fixing portion comprises a first combination portion at a lower portion of the fixing portion, the lower portion facing the printed circuit board and the printed circuit board comprising a second combination portion combined with the first combination portion.

24. The display device of claim 23, wherein the first combination portion is a protrusion and the second combination portion is a recess.

25. The display device of claim 20, wherein the second receiving portion is substantially parallel with the bottom portion and comprises a second fixing portion and a second connection portion, the second fixing portion configured to enable the board to closely contact the first region, the second connection portion being connected between the second fixing portion and the bottom portion.

26. The display device of claim 25, wherein the second connection portion is substantially parallel with the second side face and a length of the second fixing portion is substantially similar to that of the second side face.

27. The display device of claim 20, further comprising a flexible printed circuit that electrically connects the printed circuit board to the display panel.

28. The display device of claim 20, wherein the receiving container further comprises
a first face receiving the printed circuit board;
a second face opposite the first face and receiving the display panel; and
sidewalls including stepped portions supporting the display panel and being extended from edge portions of the second face.
